(19) United States
(12) Patent Application Publication
(10) Pub. No.: US 2026/0239035 A1
(43) Pub. Date: Aug. 13, 2026

(54) SYSTEMS AND METHODS FOR HANDLING OF OPERATION AND MAINTENANCE CONNECTIVITY FOR MOBILE INTEGRATED ACCESS AND BACKHAUL NODES

(71) Applicant: Telefonaktiebolaget LM Ericsson (PUBL), Stockholm (SE)

(72) Inventors: Filip Barac, Huddinge (SE); Gautham Nayak Seetanadi, STOCKHOLM (SE); Boris Dortschy, Vendelsö (SE); Junfeng Wang, OTTAWA (CA); Robert Petersen, LINKÖPING (SE); Antonino Orsino, KIRKKONUMMI (FI)

(21) Appl. No.: 19/472,822

(22) PCT Filed: Apr. 5, 2024
(86) PCT No.: PCT/IB2024/053350

§ 371 Date: Oct. 6, 2025

Related U.S. Application Data
(60) Provisional application No. 63/494,683, filed on Apr. 6, 2023.

(51) Int. Cl. H04W 24/02; H04W 60/04; H04W 76/10; H04W 92/18

(52) U.S. Cl. CPC H04W 24/02; H04W 60/04; H04W 76/10; H04W 92/18

(57) ABSTRACT

A method (700) by a network node (110) for handling of Operations and Maintenance, OAM, connectivity, includes obtaining (702) information for connecting to a plurality of OAM systems. For each one of the plurality of OAM systems, the information comprises a mapping of at least one selection criteria to a respective one of the plurality of OAM systems.

### TECHNICAL FIELD

The present disclosure relates, in general, to wireless communications and, more particularly, systems and methods for handling of Operation and Maintenance (OAM) connectivity for Mobile Integrated Access and Backhaul (IAB) nodes.

### BACKGROUND

Fifth Generation (5G) networks are being designed and deployed considering a dense deployment of small cells in order to simultaneously serve more User Equipment (UEs) with higher throughput and lower delay. However, building from scratch a completely new infrastructure is costly and takes time. Deploying a wireless backhaul is, thus, envisioned to be an economically and technically viable approach to enable flexible and dense network.

This solution was standardized in 3rd Generation Partnership Project (3GPP) Release 16, under the term Integrated Access and Backhaul (IAB), to support wireless relaying in Next Generation-Radio Access Network (NG-RAN) and has continued in Release 17. According to Release 16, the IAB architecture is based on the Centralized Unit (CU)-Distributed Unit (DU) split gNodeB (gNB) architecture that was standardized in Release 15. The CU is in charge of the radio resource control (RRC) and the packet data convergence (PCDP) protocol, whereas the DU is in charge of the radio link control (RLC) and multiple access control (MAC). The F1 interface connects the CU and the DU. The CU-DU split facilitates separate physical CU and DU, while also allowing a single CU to be connected to multiple DUs.

FIG. 1 illustrates a basic IAB architecture with donor nodes and child nodes. Specifically, FIG. 1 shows a single IAB donor connected to the core network. The IAB donor serves three direct IAB child nodes through two collocated DUs at the donor for wireless backhauling. The center IAB node in turn serves two IAB nodes through wireless backhaul. All IAB nodes in the figure backhaul traffic both related to UEs connected to it, and other backhaul traffic from downstream IAB nodes.

All IAB nodes in the figure backhaul traffic both related to UEs connected to it, and other backhaul traffic from downstream IAB nodes.

The main components of the IAB architecture are:
1) IAB Node: A node that allows wireless access to the UEs while also backhauling the traffic to other nodes. The IAB node consists of an IAB-DU that provides access to connected UEs. The node also consists of a mobile termination (IAB-MT) that connects to other IAB nodes or donors in the uplink direction for backhaul.
2) IAB Donor: A node that provides UEs an interface to the core network and wireless functionality to other IAB-nodes to backhaul their traffic to the core network.

The defining feature of IAB is the use of wireless spectrum for both access of UEs and backhauling of data through IAB donors. Thus, there needs to be clear separation of access and backhaul resources to avoid interference between them. This separation of access and backhaul resources cannot be handled during network planning due to dynamic nature of IAB.

In Release 16, IAB was standardized with basic support for multi-hop multi-path backhaul for directed acyclic graph (DAG) topology, no mesh-based topology was supported. Rel 16 also supports Quality of Service (QOS) prioritization of backhaul traffic and flexible resource usage between access and backhaul. Discussions in Release 17 are on topology enhancements for IAB with partial migration of IAB nodes for Radio Link Failure (RLF) recovery and load balancing.

The following references provide further information about standardized IAB work:
Madapatha, Charitha et al., “On Integrated Access and Backhaul Networks: Current Status and Potentials,” IEEE Open Journal of the Communications Society 1, 2020, pages 1374-1389
3GPP TS 38.300. Section 4.7
3GPP TR 38.874 Study on IAB

When IAB node joins the network, it executes an IAB node integration procedure, which is described in 3GPP TS 38.401v 17.4.0 . The OAM for IAB nodes is also described in 3GPP TS 38.401v 17.4.0 .

The Release 17 specifications support partial inter-donor migration of IAB-nodes, where the IAB-MT of an IAB-node is handed over between two donor CUs, while the F1 traffic traversing or terminated at the co-located IAB-DU is redirected to traverse the donor DU serving the IAB-MT after the IAB-MT handover (HO). Specifically,

3GPP TS 38.401 v 17.4.0 describes partial migration where the donor CU that hands over the IAB-MT to another donor CU is referred to as the source IAB-donor-CU. This donor CU keeps serving the IAB-DU before and after the IAB-MT handover. The donor CU to which the IAB-MT is handed over is referred to as the target IAB-donor-CU.

In Release 18, it is expected that the different RAN groups will work towards enhancing functionality of IAB through mobile-IAB providing 5G coverage enhancement to onboard and surrounding UEs. The initial use cases for mobile-IAB/VMR (vehicle mounted relay) are expected to be based on 3GPP TR 22.839v 18.1.0 .

One of the main use cases of mobile IAB cell is to serve the UEs which are residing in the vehicle with the vehicle mounted relay. Other relevant use cases for mobile IABs involves a mobile/nomadic IAB network node mounted on a vehicle that provides extended coverage. This involves scenarios where additional coverage is required during special events like concerts, or during disasters. The nomadic IAB node provides access to surrounding UEs while the backhaul traffic from the nomadic IAB node is then transmitted wirelessly either with the help of IAB donors or non-terrestrial networks (NTN). A nomadic IAB node also reduces or even eliminates signal strength loss due to vehicle penetration for UEs that are present in the vehicles. An advantages of Mobile IAB includes reducing/eliminating the vehicle penetration loss (specially at high frequency). Another advantage includes reducing/eliminating group handover.

In most use cases, the mobile IAB is expected to be mounted on public transport vehicles and to move to a large extent in a pre-determined route. FIG. 2 illustrates one such mobile IAB mounted on a bus travelling on a route that is covered by 4 different parent IAB nodes (IAB Parent 1,2,3,4). The parent nodes backhaul their traffic through 2 donor nodes (Donor IAB X, Y). As illustrated in FIG. 2, the example scenario includes Intra-Donor, Inter-Donor (same CU), and Inter CU.

An IAB node has an IAB-DU that provides access to UEs around it and an IAB-MT that provides a backhaul connection of the IAB node to its parent(s) and the rest of the network. The parent IAB nodes consist of IAB-DUs that provide access to UEs and the mobile IAB present in their coverage. IAB-nodes also consist of an IAB-MT that backhauls its traffic together with traffic from the mobile IAB node. Finally, the two donor nodes consist of DU that provides access and CU that is connected to the core network. The CUs in both donor nodes maintain a F1 connection to IAB-DUs under it.

When the mobile IAB node moves from one geographical area to the next, it passes through different areas covered by various cells of stationary parent nodes.

In general, 3GPP assumes that the mIAB-DU migration between different donor-CUs will be realized by powering up a second logical mIAB-DU in an mIAB node (IAB-DU2), that will establish F1 connection to the target donor CU for mIAB-DU migration (IAB-donor-CU2). Then, the UEs served by the mIAB-node will be handed over from a cell of mIAB-DU1 controlled by source donor CU (CU1) to a cell of mIAB-DU2 controlled by target donor CU (CU2). The two cells reside on the same physical IAB-node but they each have a separate FI connection to IAB-donor-CU1 and IAB-donor-CU2, respectively. After UEs are handed over between the mIAB-DU1 and mIAB-DU2, the F1 connection between the mIAB-DU1 and IAB-donor-CU1 is released. FIG. 3 illustrates an example mIAB-MT with two logical DUs with F1 connections to different donor CUs.

Regarding the interaction between the mIAB-MT handover between two donors and the inter-donor migration of the co-located mIAB-DU, RAN3 agreed to the following:
As already supported in Rel17, a mobile IAB-MT and its co-located mobile IAB-DU may be served by different donor CUs.
The mobile IAB donor that the co-located IAB-DU connects to may remain unchanged after the IAB-MT HO.
RAN3 to discuss whether a mobile IAB-DU can execute inter-donor migration, while the co-located mobile IAB-MT stays connected to the same donor before and after the mobile IAB-DU migration.
RAN3 to discuss whether a mobile IAB-DU can execute inter-donor migration, while the co-located mobile IAB-MT executes inter-donor migration.
When IP connectivity between target IAB-donor DU and source IAB-donor CU is available, and when Xn connectivity between source and target donor CU is available, the Rel-17 partial migration is used as baseline for supporting the F1 transport migration and inter-donor routing when an mobile IAB-DU and its co-located mobile IAB-MT are connected to different donor CUs.
The mobile IAB-node may perform multiple consecutive partial migrations without inter-donor migration of its mobile IAB-DU.
RAN3 to discuss how inter-donor topology adaptation can be supported for mobile IAB in absence of Xn and/or inter-donor IP routability.
Rel17 mechanisms support intra donor CU migration of mobile IAB.
For DU migration cases, to execute the handover of the served UEs, the mobile IAB-node concurrently supports two logical mobile IAB-DUs, which have FIAP associations with the source CU and the target CU, respectively.
The UEs connected to the mobile IAB-node are handed over from the cell of the logical mobile IAB-DU (i.e., the source logical mobile IAB-DU) that has an F1AP association with the source CU to the cell of the logical mobile IAB-DU (i.e., the target logical mobile IAB-DU) that has an F1AP association with the target CU.
mIAB-DU migration and mIAB-MT handover can be executed independently from each other. Details on the scenarios need to be further discussed.
For partial migration of mIAB-node, the inter-donor HO of mIAB-MT is decided and triggered by the donor CU serving the mIAB-MT.
The donor CU serving the mIAB-DU decides whether to execute mIAB-DU migration or inter-donor F1 transport migration for the mIAB-DU.
For inter-donor partial migration, the donor CU serving the mIAB-DU is informed about the mIAB-MT HO. FFS on signalling details concerning the indication.
WA: The source donor CU for the mIAB-MT HO provides to the donor CU serving the mIAB-DU at least the:
gNB ID of the target donor CU for the mIAB-MT HO.
ID(s) of the mIAB-MT. How the mIAB-MT ID is maintained across migrations needs to be further discussed
For future study: the TNL address of the target donor CU for the mIAB-MT HO.
For partial migration of mIAB-node, the donor CU serving the mIAB-DU and the target donor CU for the mIAB-MT HO can directly exchange Xn IAB Transport Migration messages, in case direct Xn connectivity exists (or is established) between the two donor CUs.
Focus first on the scenarios where Xn and IP connectivity are available between the source and target donors for IAB-MT HO and mIAB-DU migration.
RAN3 to discuss support of mIAB-node mobility over NGAP. Which type of migration needs to be further discussed.
To hand over the UEs between the logical mIAB-DUs, the source donor CU for mIAB-DU migration should be notified about the cell IDs served by the second (target) logical mIAB-DU.
The source donor CU for mIAB-DU migration should be informed that the second logical mIAB-DU has successfully established an F1 connection towards the target CU. Details are FFS.
WA: The mIAB-MT and its co-located mIAB-DU can be handed over/migrated to different donor CUs. This WA is subject to validation that the impact involved is affordable.
The source donor CU for the mIAB-MT HO provides to the donor CU serving the mIAB-DU at least the:
gNB ID of the target donor CU for the nIAB-MT HO.
ID(s) of the mIAB-MT. How the mIAB-MT ID is maintained across migrations needs to be further discussed.
In case the donor of the mIAB-DU decides the F1AP setup for DU migration, the donor of the mIAB-DU triggers via F1 signalling the IAB node to perform the F1 Setup procedure for the DU migration. An OAM based solution is not excluded.
For the establishment of Xn, the mIAB-DU's donor CU can obtain the TNL address of the mIAB-MT's target donor CU via legacy mechanisms.
The info sent by the mIAB-MT's source donor CU to the mIAB-DU's donor CU does not include the target donor CU's TNL address.
The mIAB-MT's source donor CU can send the info on the mIAB-MT's target donor CU to the mIAB-DU's donor CU after the completion of IAB-MT HO.
The mIAB-MT ID sent by the mIAB-MT's source donor CU to the mIAB-DU's donor CU is the XnAP UE ID. FFS which donor generates this ID.
The trigger for F1 setup between the mobile IAB-node's second logical DU and its donor CU may be based on OAM or pre-configuration
When triggering the F1 Setup procedure on the mIAB-node, the source logical mIAB-DU's CU to include the information of target logical mIAB-DU's CU (e.g. IP address, gNB-ID).
The IAB-node can inform the source logical mIAB-DU's CU via F1AP about the successful F1 Setup with the target logical mIAB-DU's CU, and it can include the IDs of the cells activated by the target logical mIAB-DU's CU.
In case the target logical mIAB-DU's CU is different from the mIAB-MT's CU, the target logical mIAB-DU's CU needs to be informed about the mIAB-MT's CU ID and the mIAB-MT ID so that it can initiate the Xn TMM procedures towards mIAB-MT's CU.
The HO of UEs from the source logical mIAB-DU's CU to the target logical mIAB-DU's CU should happen after the completion of the F1 setup. When to trigger the HO is up to source logical mIAB-DU's CU implementation.
After all UEs have been handed over, the source logical mIAB-DU's F1AP association can be released by the source logical mIAB-DU or by the source logical mIAB-DU's CU.
Target donor CU selection for mIAB-DU migration and triggering conditions for F1 setup can be up to source CU implementation (unless it is justified that this is not possible) or based on OAM configuration at the source CU.
RAN3 not to work on solutions addressing use cases where inter donor IP connectivity is not available.
For scenarios without Xn, RAN3 to investigate whether IAB-related Xn signaling for partial migration and DU migration can be carried via NG using a container to avoid the impact on the AMF.

Plug and connect (PnC) is the procedure that a network node uses to initiate an IP connection to OAM network. Plug and connect to OAM system includes the steps of initial IP autoconfiguration, Certificate enrollment, establishing a secure connection to SeGW and Establishing a secure connection to Software configuration server (SCS). The initial IP autoconfiguration obtains client IP configuration and IP address or Fully Qualified Domain Names (FQDN) of Certification Authority(CA)/Registration Authority (RA), SeGW and SCS via DHCP request. To perform CA/RA enrollment, the Network Element may be provisioned with operator's root certificate if the root certificate is not obtained during CMPv2 protocol (TS 33.310v18.0.0 ). 3GPP TS 28.314, TS 28.315 and TS 28.315 specify stage 1/2/3 descriptions for the Plug and Connect:
TS 28.314v17.0.0 : “plug and connect; Concepts and requirements”.
TS 28.315v17.0.0 : “plug and connect; Procedure flows”.
TS 28.316v17.0.0 : “plug and connect; Data formats”.

There currently exist certain challenge(s), however. For example, the RAN3 working group in 3GPP is currently discussing the support for mIAB-node mobility, where the mIAB-MT handover and mIAB-DU migration are discussed separately, based on the assumption that the mIAB-MT and mIAB-DU can be handed over to different target donors.

In general, 3GPP assumes that the mIAB-DU migration between different donor-CUs will be realized via following steps:
1. The donor CU of mIAB-DU (herein referred to as the donor-CU1 or CU1) decides to perform migration of mIAB-DU1 to another donor CU and determines the target donor CU (herein referred to as the donor-CU3).
2. CU1 instructs the mIAB-DU1 to power up a second logical mIAB-DU in the mIAB node (mIAB-DU2) and provides the IP address and gNB ID of the selected target donor (CU3) for mIAB-DU2 to connect to.
3. mIAB-DU2 is powered up, it connects to the OAM system and downloads (or is provided in another way) the necessary configurations, needed for it to operate.
4. mIAB-DU2 initiates F1 connection establishment towards the target donor CU for mIAB-DU migration (CU3).
5. If the F1 connection is successfully established, the mIAB-DU2, e.g., via node-internal signaling, notifies the mIAB-DU1 that the F1 connection towards the CU3 has been successfully established, and indicates the IDs of the cells activated at the mIAB-DU2.
6. mIAB-DU1 notifies CU1 that the F1 connection between mIAB-DU2 and the CU3 and indicates to CU1 the IDs of the cells activated at mIAB-DU2.
7. CU1 initiates the handover of the UEs served by the mIAB-DU1 from a cell of mIAB-DU1 controlled by source donor CU (CU1) to a cell of mIAB-DU2controlled by target donor CU (CU3). The two cells reside on the same physical IAB-node but they each have a separate F1 connection to IAB-donor-CU1and IAB-donor-CU3, respectively, see Error! Reference source not found.
8. After UEs are handed over between the mIAB-DU1 and mIAB-DU2, the F1 connection between the mIAB-DU1 and IAB-donor-CU1 is released.

With respect to the Step 3, when the second logical mIAB-DU (mIAB-DU2) is powered up, it needs to connect to the OAM system and download (or is provided in another way) network configurations. However, there may exist several OAM systems with each being responsible for, a different region of the country, for example. In some scenarios, the mIAB nodes could be mounted onboard public transport vehicles that may travel large distances. Meanwhile, one of the requirements for mIAB specification work states that the mIAB framework should support both the scenarios with deterministic and with random trajectories of mIAB nodes. Consequently, which OAM system that the mIAB-DU2 should connect to may depend on the physical location of the mIAB node at the time when the mIAB-DU2 is powered up. However, it is unclear how to ensure that the mIAB-DU2 connects to the appropriate OAM system.

### SUMMARY

Certain aspects of the disclosure and their embodiments may provide solutions to these or other challenges. For example, methods and systems are provided for enabling the mIAB node to establish a connection with an OAM system, regardless of where it moves inside the network. This enables the mIAB-DU to download the configurations from the OAM whenever it connects to a new donor CU.

According to certain embodiments, a method by a network node for handling OAM connectivity includes obtaining information for connecting to a plurality of OAM system. For each one of the plurality of OAM systems, the information comprises a mapping of at least one selection criteria to a respective one of the plurality of OAM systems.

According to certain embodiments, a network node for handling OAM connectivity is configured to obtain information for connecting to a plurality of OAM system. For each one of the plurality of OAM systems, the information comprises a mapping of at least one selection criteria to a respective one of the plurality of OAM systems.

According to certain embodiments, another method by a network node for handling OAM connectivity includes transmitting, to a second network node, information for connecting to a plurality of OAM systems. For each of the plurality of OAM systems, the information comprises a mapping of at least one selection criteria to a respective one of the plurality of OAM systems. According to certain embodiments, a first network node for handling OAM connectivity is configured to transmit, to a second network node, information for connecting to a plurality of OAM systems. For each of the plurality of OAM systems, the information comprises a mapping of at least one selection criteria to a respective one of the plurality of OAM systems.

Certain embodiments may provide one or more of the following technical advantage(s). For example, certain embodiments may provide a technical advantage of enabling the mIAB node to establish a connection with an OAM system, regardless of where it moves inside the network. This enables the mIAB-DU to download the configurations from the OAM whenever it connects to a new donor CU. This is essential for the operation of mIAB nodes.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates a basic IAB architecture with donor nodes and child nodes;

FIG. 2 illustrates an example mobile IAB node scenario including Intra-Donor, Inter-Donor (same CU), and Inter CU;

FIG. 3 illustrates an example mIAB-MT with two logical DUs with F1 connections to different donor CUs;

FIG. 4 illustrates an example communication system, according to certain embodiments;

FIG. 5 illustrates an example UE, according to certain embodiments;

FIG. 6 illustrates an example network node, according to certain embodiments;

FIG. 7 illustrates a block diagram of a host, according to certain embodiments;

FIG. 8 illustrates a virtualization environment in which functions implemented by some embodiments may be virtualized, according to certain embodiments;

FIG. 9 illustrates a host communicating via a network node with a UE over a partially wireless connection, according to certain embodiments;

FIG. 10 illustrates an example method by a network node for handling OAM connectivity, according to certain embodiments; and

FIG. 11 illustrates another example method by a network node for handling OAM connectivity, according to certain embodiments.

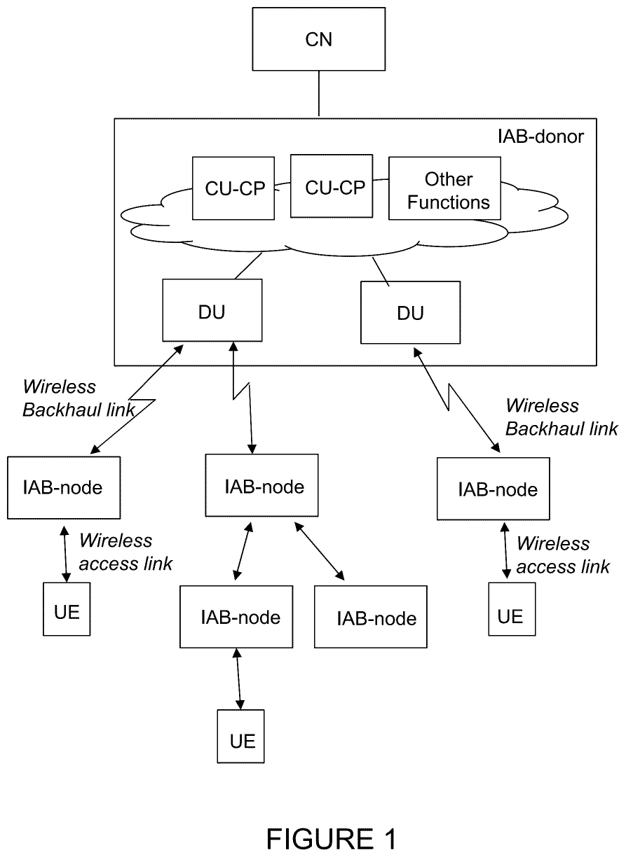

### DETAILED DESCRIPTION

Some of the embodiments contemplated herein will now be described more fully with reference to the accompanying drawings. Embodiments are provided by way of example to convey the scope of the subject matter to those skilled in the art.

As used herein, ‘node’ can be a network node or a UE. Examples of network nodes are NodeB, base station (BS), multi-standard radio (MSR) radio node such as MSR BS, eNodeB (eNB), gNodeB (gNB), Master eNB (MeNB), Secondary eNB (SeNB), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operations & Maintenance (O&M), Operations Support System (OSS), Self Organizing Network (SON), positioning node (e.g. E-SMLC), etc.

Another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

In some embodiments, generic terminology, “radio network node” or simply “network node (NW node)”, is used. It can be any kind of network node which may comprise base station, radio base station, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g. in a gNB), Distributed Unit (e.g. in a gNB), Baseband Unit, Centralized Baseband, C-RAN, access point (AP), etc.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IoT), WiFi, Bluetooth, next generation RAT, NR, 4G, 5G, etc. Any of the equipment denoted by the terms node, network node or radio network node may be capable of supporting a single or multiple RATs.

The term signal or radio signal used herein can be any physical signal or physical channel. Examples of downlink (DL) physical signals are reference signal (RS) such as Primary Synchronization Signal (PSS), Secondary Synchronization Signal (SSS), Channel State Information-Reference Signal (CSI-RS), Demodulation Reference Signal (DMRS) signals in SS/PBCH block (SSB), discovery reference signal (DRS), Cell Specific Reference Signal (CRS), Positioning Reference Signal (PRS), etc. RS may be periodic. For example, RS occasions carrying one or more RSs may occur with certain periodicity (e.g., 20 ms, 40 ms, etc.). The RS may also be aperiodic.

Each SSB carries New Radio-Primary Synchronization Signal (NR-PSS), New Radio-Secondary Synchronization Signal (NR-SSS) and New Radio-Physical Broadcast Channel (NR-PBCH) in four successive symbols. One or multiple Synchronization Signal Blocks (SSBs) are transmitted in one SSB burst which is repeated with certain periodicity such as, for example, 5 ms, 10 ms, 20 ms, 40 ms, 80 ms, and 160 ms. The UE is configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset with regard to reference time (e.g., serving cell's SFN) etc. Therefore, SMTC occasion may also occur with certain periodicity (e.g., 5 ms, 10 ms, 20 ms, 40 ms, 80 ms, and 160 ms). Examples of uplink (UL) physical signals are reference signals such as Sounding Reference Signals (SRS), Demodulation Reference Signals (DMRS), etc. The term physical channel refers to any channel carrying higher layer information e.g. data, control etc. Examples of physical channels are Physical Broadcast Channel (PBCH), Physical Downlink Control Channel (PDCCH), Physical Downlink Shared Channel (PDSCH), Physical Uplink Shared Channel (PUSCH), Physical Uplink Control Channel (PUCCH), Physical Uplink Shared Channel (PUSCH), Short PUSCH (sPUCCH), Short PDSCH (SPDSCH), Short PUCCH (sPUCCH), Short PUSCH (sPUSCH), MTC PDCCH (MPDCCH), Narrowband PBCH (NPBCH), Narrowband PDCCH (NPDCCH), Narrowband PDSCH (NPDSCH), Narrowband PUSCH (NPUSCH), Enhanced PDCCH (E-PDCCH), etc.

The term time resource used herein may correspond to any type of physical resource or radio resource expressed in terms of length of time. Examples of time resources are: symbol, time slot, subframe, radio frame, TTI, interleaving time, slot, sub-slot, mini-slot, system frame number (SFN) cycle, hyper-SFN (H-SFN) cycle etc.

The terms “mIAB-DU migration” and “mIAB-DU handover” are used interchangeably. The terms “source donor CU” and “donor-CU serving the mIAB-DU1” are used interchangeably.

The terms “target donor-CU” and “target CU” are used interchangeably.

The solution proposed in this invention applies NR as well as future RATs such as 6G.

The terms “OAM”, “OAM system” and “OAM system” are used interchangeably.

The terms “first logical mIAB-DU” or “mIAB-DU1” are used interchangeably.

The terms “second logical mIAB-DU” or “mIAB-DU2” are used interchangeably.

### Solution Overview

According to certain embodiments, a method is provided for enabling the mIAB-node to obtain a list of instructions for connecting to different OAM systems as it moves around the network. According to certain particular embodiments, the mIAB node obtains the list during the power up and plug and connect procedure, and, later, provision of the above list to the mIAB-node at every mIAB-DU inter-donor migration. This will ensure that the new logical mIAB-DU can connect to an appropriate OAM.

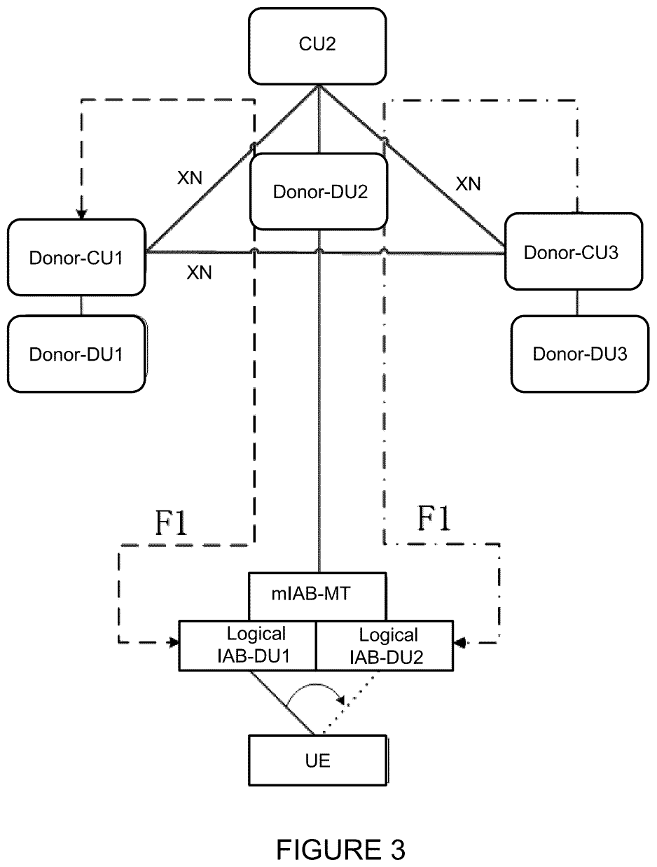

According to certain embodiments, for example, a method is provided for the mIAB node's second logical mIAB-DU (i.e., the mIAB-DU2) to connect to the OAM and obtain IP address and other related configurations during power-up through the plug and connect procedure. According to various particular embodiments, the method may include any one or more of the following steps:
The mIAB is already in operation serving UEs via the first logical mIAB-DU (i.e., mIAB-DU1), which has an F1 connection to a CU1. The mIAB-MT is being served by, i.e., has an RRC connection to, a donor CU2.
The mIAB moves to a new location and it is required to migrate the F1-connection to a new IAB-donor, IAB-donor-CU3, that is connected to an OAM that is different from the OAM that IAB-donor-CU1 is connected to.
The mIAB decides (or is instructed) to start a new (logical) mIAB-DU, called second logical mIAB-DU, or logical mIAB-DU2, as shown in FIG. 3.
The mIAB-DU2 needs select a proper OAM system to connect to and to perform the plug and connect procedure and obtain the required configurations.
Once the mIAB-DU2 has powered up and received the configurations, it established an F1 connection to a target donor CU (CU3 as described above), after which the UEs are handed over from mIAB-DU1 to mIAB-DU2.
The mIAB-DU1 is powered off.

It is noted that at every mIAB-DU migration, the logical mIAB-DU entity in the mIAB-node that was active prior to mIAB-DU migration is referred to as the “first logical mIAB-DU” or “mIAB-DU1”. The logical mIAB-DU entity that is powered up as a part of the mIAB-DU migration (as explained above), and that establishes the F1 connection with the target CU is referred to as the “second logical mIAB-DU” or “mIAB-DU2”. This process repeats continuously, meaning that, at every mIAB-DU migration, the mIAB-DU active before the migration plays the role of first logical mIAB-DU, while the logical mIAB-DU that is powered up as a part of mIAB-DU migration plays the role of second logical mIAB-DU.

### Example Solution

According to certain embodiments, the mIAB-DU is pre-configured with IP addresses and/or FQDN for all the available OAM systems that the mIAB-DU might connect to, and the OAM system to connect to is chosen based on a mapping intelligence. For example, when an mIAB-node joins the network such as, for example, during the integration procedure (as described in 3GPP TS 38.401v 17.4.0 ), the mIAB-node obtains a list of instructions, which may include, for example, mappings between selection criteria and OAM systems, for connecting to different OAM systems (henceforth referred to as “the list”). According to various particular embodiments, the list of instructions and/or mappings can be obtained in one or more of the following ways:
From the first OAM system that it connects to;
From the first donor that serves it or by any donor that serves it; and/or
By pre-configuration, which could be, e.g., manual.

In another particular embodiment, the list is obtained and/or updated later, from an OAM sever or from the current serving donor.

In another particular embodiment, if the same OAM system that served mIAB-DU1 should serve the mIAB-DU2, the donor CU serving the mIAB-DU1 indicates to the mIAB-DU1 that the same server will serve mIAB-DU2, effectively meaning that the list should not be consulted, but rather that the mIAB-DU1 should share the “contact details” of the OAM system with mIAB-DU2, i.e., the information needed for the mIAB-DU2 to establish a connection to the OAM system (e.g., the IP address of the OAM system). In this case, although the same OAM system serves both mIAB-DU1 and mIAB-DU2, they each need to individually maintain the connection to this server.

In another particular embodiment, the above indication is received by the mIAB-DU1 from its own OAM system, based on the information provided to the OAM system by the mIAB-DU1.In still another particular embodiment,

if the donor CU of mIAB-DU1 is unaware that the same OAM system will be used for mIAB-DU2, the mIAB-DU2 consults the list, which can effectively result in choosing the same OAM system.

According to certain embodiments, each entry in the instruction list contains at least one of:
one or more trigger/selection conditions for selecting an OAM system for initiating a connection to this OAM system; and/or
parameters needed for establishing a connection to the OAM system.

In a particular embodiment, at each mIAB-DU migration, when the second logical mIAB-DU is powered up, but before it initiates the establishment of an F1 connection to the target donor CU for mIAB-DU migration, the first logical mIAB-DU can (optionally) pass the list to the second logical mIAB-DU by means of node-internal signalling.

The newly powered-up logical mIAB-DU evaluates the triggering/selection conditions stated in the list, and based on the satisfied condition, chooses an OAM system to contact. The OAM connection can be established by means of IP connectivity over backhaul or by means of PDU session from the co-located mIAB-MT.

After establishing the connection with the OAM system, the mIAB-DU2 downloads the appropriate configuration parameters needed for its operation, after which it initiates the establishment of F1 connection to the target CU. In case the IP address(es) for the mIAB-node is obtained from the mIAB-MT's donor, the IP autoconfiguration step of the Plug and connect procedure may be omitted.

Obtaining the Instruction List by the Second Logical mIAB-DU

In a particular embodiment, the mIAB-DU2 obtains information related to the OAM system to connect to from the mIAB-MT.

In another particular embodiment, the mIAB-DU2 obtains information related to the OAM system to which to connect to from the donor CU that the first logical mIAB-DU has an F1 connection with.

In another particular embodiment, the second logical mIAB-DU obtains information related to the OAM system to connect to from the first logical mIAB-DU. In one example of this embodiment, the information related to the OAM system to connect to is shared via a direct (physical) interface between the first logical mIAB-DU and the second logical mIAB-DU. In another example of this embodiment, the information related to the OAM system to connect to is shared via a logical interface between the first logical mIAB-DU and the second logical mIAB-DU. Herein, a logical interface means that the first logical mIAB-DU may reach the second logical mIAB-DU by use of other intermediate network nodes, such as a donor CU.

In another particular embodiment, the second logical mIAB-DU obtains information related to the OAM via pre-configuration. This means that in the software loaded on the hardware that host the second logical mIAB-DU is already included information to which OAM system to connect, and under what circumstances.

### The Evaluation of Triggering/Selection Conditions for Connecting to an OAM System

At power-up, unless instructed otherwise by the mIAB-DU1 (e.g., in case the mIAB-DU2should use the same OAM system as mIAB-DU1, as described above), the mIAB-DU2 checks the list to find the appropriate OAM system. The mIAB-DU2 selects the OAM system by going through the list and checking which triggering/selection condition is satisfied, whereas each entry in the list can have one or multiple triggering/selection conditions, each of which may be unique or shared with other entries in the list.

In various particular embodiments, each entry of the list may contain one or more of:
one or more triggering/selection conditions, as described further below; and/or
parameters needed for establishing a connection to the OAM system:
   In a further particular embodiment, the information provided to the second logical DU can be an IP address of the OAM system that serves the donor CU that has a FI connection to the first logical DU.
   In a further particular embodiment, the information provided to the second logical DU can be IP address or FQDN of OAM system (CA/RA, SeGW and SCS).
   In a further particular embodiment, the information provided to the second logical DU can be a list of IP addresses and the associated TACs that are served by the different OAMs. The logical DU can then choose the appropriate OAM depending upon the different trigger conditions described below.
an identifier of the OAM system towards which the OAM connection should be initiated, based on the above triggering/selection criteria and connection establishment parameters.

According to certain embodiments, based on the information collected by itself or provided to it by the mIAB-MT or by the mIAB-DU1, the mIAB-DU2 performs one or more of:
1. Checks which of the triggering/selection condition(s) is satisfied.
2. Selects an OAM system in the list entry for which the triggering/selection condition(s) is satisfied.
3. Initiates connection establishment towards the OAM system, by using the parameters needed for establishing a connection towards this OAM system, indicated in the selected list entry.

For example, if the triggering/selection condition is that the mIAB-MT of the mIAB-node is connected to cell X, the mIAB-DU2 will ask the mIAB-MT to provide to the mIAB-DU2 the ID of the cell to which it is connected. The mIAB-DU2 will select the entry of the list corresponding to the criterion: “mIAB-MT connected to cell X”.

In various particular embodiments, the triggering/selection conditions may contain one or more of the following:
The gNodeB Identifier (gNB ID) pertaining to the donor CU that currently serves the mIAB-MT.
The cell that the mIAB-MT is connected to, denoted by NR Cell Global Identity (CGI) or Physical Cell Identity (PCI).
The Tracking Area Identity (TAI), Tracking Area Code (TAC) and/or the RAN Notification Area Code (RANAC), or Registration Area (RA) pertaining to the cell where the mIAB-MT is connected.
The Tracking Area Identity (TAI), Tracking Area Code (TAC) and/or the RAN Notification Area Code (RANAC), Registration Area (RA) pertaining to the cells served by the mIAB-DU1.
   It is noted that the TAC/RANAC of the mIAB-DU1 may be updated even if the mIAB-DU1 remains connected to the same donor CU before and after the change of TAC/RANAC. The reason is that the TAC/RANAC may need to reflect the area in which the mIAB-node is physically located.
   In a particular embodiment, the information above may be identical to the information pertaining to the cell where the mIAB-MT is connected.
The Public Land Mobile Network identifier (PLMN ID) pertaining to the cell that currently serves the mIAB-MT.
The current geographical coordinates/positioning information of the mIAB-DU1/mIAB-MT.
   The mIAB-MT may estimate its location and report it to its donor CU the position information of the mIAB-MT and the co-located mIAB-DU1 via Access and Mobility Management Function (AMF) and Location Management Function (LMF).
   The donor CU of mIAB-DU1 may receive the position information of the mIAB-MT/mIAB-DU1 which is estimated by the LMF based on the measurement reports of the positioning reference signals such as, for example DL Positioning Reference Signal (DL PRS), UL Sounding Reference Signal (UL SRS) etc.
The information reported from the UEs served by the mIAB-DU1 to the source CU.
   In a particular embodiment, the information reported by the UEs may include the indication of cells IDs or RANAC in the measurement reports sent from the UEs served by the mIAB-DU1 to its CU. In addition, a SON/ANR feature enables the UEs to read SIB1, which contains PLMN ID, TAC, CGI, RANAC, and this info may also be reported to the mIAB-DU1's CU by the UE and used as area information of the mIAB-node.
   The underlying intuition is that, if a UE can measure the signal from a cell that it is not necessarily connected to, it means that the UE is located inside or in the vicinity of the cell's coverage area.
   A list of PCIs that a UE has detected but that were not listed in the list of PCIs (provided by the CU) to be measured.
   The positioning information of the served UEs
      The UE may estimate and report its position to the LMF based on positioning reference signals (e.g., DL PRS, UL SRS, etc.) configured to the UE. Other positioning information such as velocity and direction (N, S, W, E) are also reported.
      The LMF may estimate the position of the served UEs based configured positioning references signals (e.g., DL PRS, UL SRS etc).
      The positioning information can be conveyed from LMF to the served CU via AMF.
The mIAB-MT and/or certain percentage of the UEs are configured with features such as Automatic Neighbour Relations (ANR)/SON (self-organizing Network) such that the mIAB-MT/UE log their position and report a mobility history (visited cells) including the current position and current cell. Other positioning information such as velocity and direction (N, S, W, E) is also reported. The reporting is done to the CU. The triggering/selection conditions can be a function of the outcome of the reporting.
Any path (route information) which is known is provided.

In the above list, some of the information may not be directly available to the mIAB-DU2,so the mIAB-DU2 needs to obtain it from another entity such as, for example, the mIAB-MT or the mIAB-DU1.

Once the mIAB-DU2 determines which OAM system to connect to, it establishes a connection to it and fetches the necessary configurations by performing <get> operations by DN of Managed Element. Then it may initiate F1 setup with the target donor CU and so on.

### Selecting and Connecting to the OAM System

In various particular embodiments, where the mIAB-node is always served by one OAM system as it moves through the network, the following variant embodiments are possible:
The mIAB-DU1 inquires the co-located mIAB-MT and obtains the information about the cell to which the mIAB-MT is connected and/or the tracking area and/or the PLMN, and/or any of the information mentioned above. After fetching the information, the mIAB-DU1 indicates this information to the OAM system, and based on this information, the OAM system determines the configuration parameters for the mIAB-DU2, and indicates these configuration parameters to the mIAB-DU1. The mIAB-DU1 passes configuration parameters to the mIAB-DU2.
Alternatively, instead of the configuration parameters for mIAB-DU2, the OAM system sends to mIAB-DU1 the “contact details” of the OAM system that the mIAB-DU2 should use, i.e., the information needed for the mIAB-DU2 to establish a connection to the OAM system (e.g., the IP address of the OAM system). The mIAB-DU1 then passes this information to mIAB-DU2 (e.g., via node-internal signalling), based on which the mIAB-DU2 will establish a connection to the OAM system and download the configuration.
In case the OAM system does not contain the “contact details” of other OAM systems (IP addresses etc.), such information is obtained by the mIAB-DU from DHCP server.

In another particular embodiment, where the mIAB-node is served by different OAM systems as it moves through the network, the following variant embodiments are possible:

In a particular embodiment, the mIAB-DU1 inquires the co-located mIAB-MT and obtains the information about the cell to which the mIAB-MT is connected and/or the tracking area and/or the PLMN, and/or any of the information described herein. After fetching the information, the mIAB-DU1 indicates this information to the OAM system, and the OAM system, based on this information, determines and sends to the mIAB-DU1 the “contact details” of another OAM system that mIAB-DU2should connect to, i.e., the information needed for the mIAB-DU2 to establish a connection to the OAM system (e.g., the IP address of the OAM system). The mIAB-DU1 then passes this info to mIAB-DU2, (e.g., via node-internal signalling) based on which the mIAB-DU2 will establish a connection to the OAM system and download the configuration.
In a particular embodiment, the mIAB-DU2 connects to the appropriate OAM system and indicates one or more of the information described herein. Based on this information, the OAM system provides the configuration parameters to the mIAB-DU2.
In another particular embodiment, the mIAB-DU2 obtains the “contact details” of the OAM system from the donor serving the mIAB-MT. The mIAB-DU2 invokes the mIAB-MT to send such a request to its donor CU.

After the mIAB-DU2 is configured, it may initiate F1 setup with the target donor CU and on.

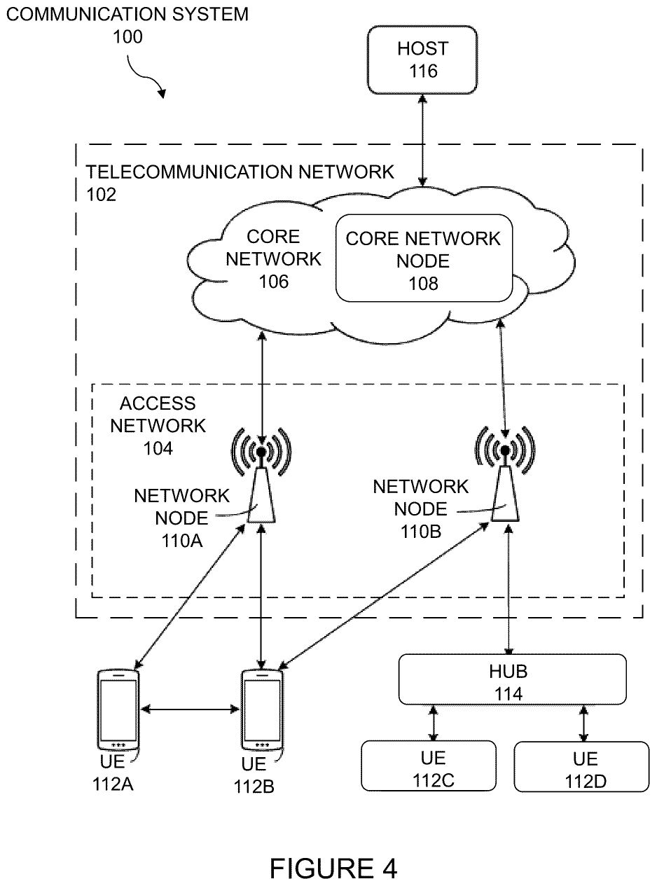

FIG. 4 shows an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more which may be generally referred to as network nodes 110), or any other similar 3rd Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server. As a whole, the communication system 100 of FIG. 4 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub-that is, a hub whose primary function is to route communications to/from the UEs from/to the network node 110b. In other embodiments, the hub 114 may be a non-dedicated hub-that is, a device which is capable of operating to route communications between the UEs and network node 110b, but which is additionally capable of operating as a communication start and/or end point for certain data channels.

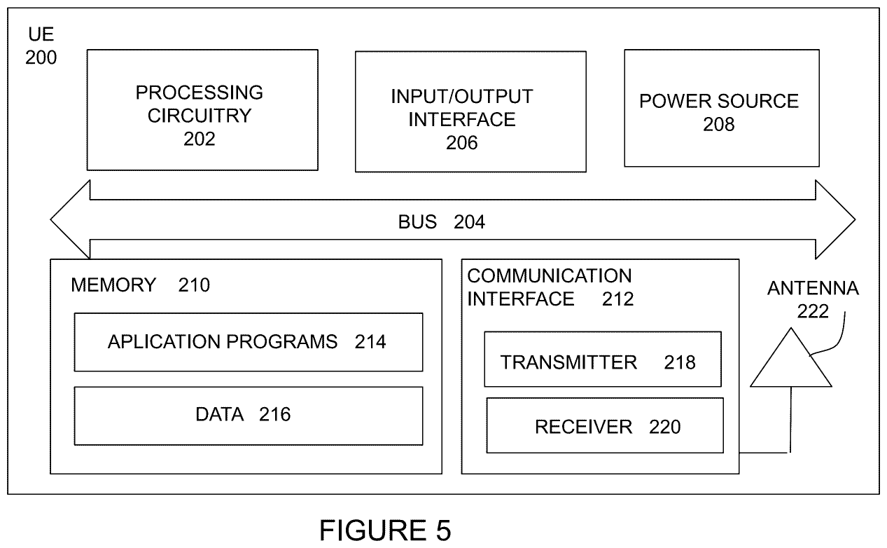

FIG. 5 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 5. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient). As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 5.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

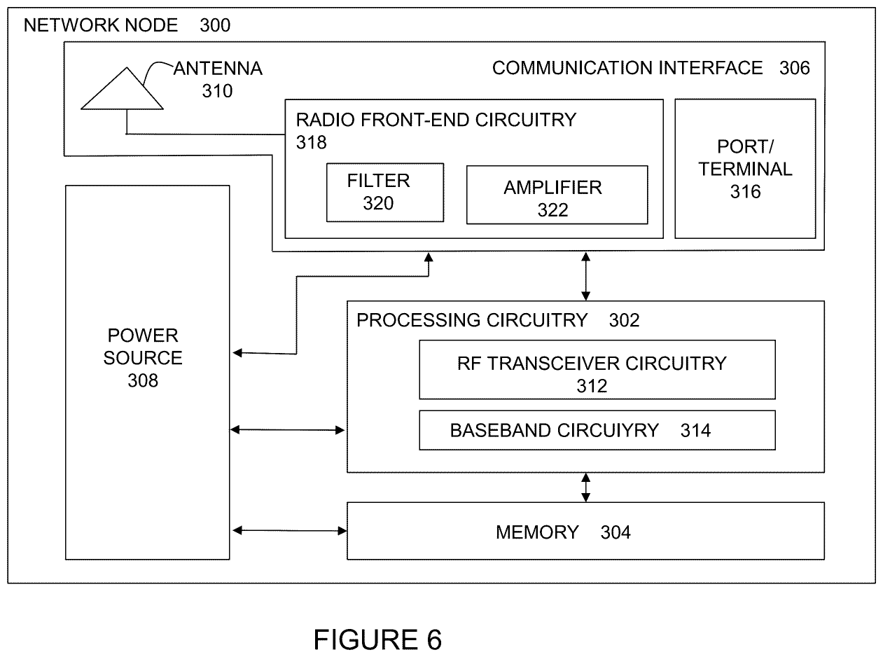

FIG. 6 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 6 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

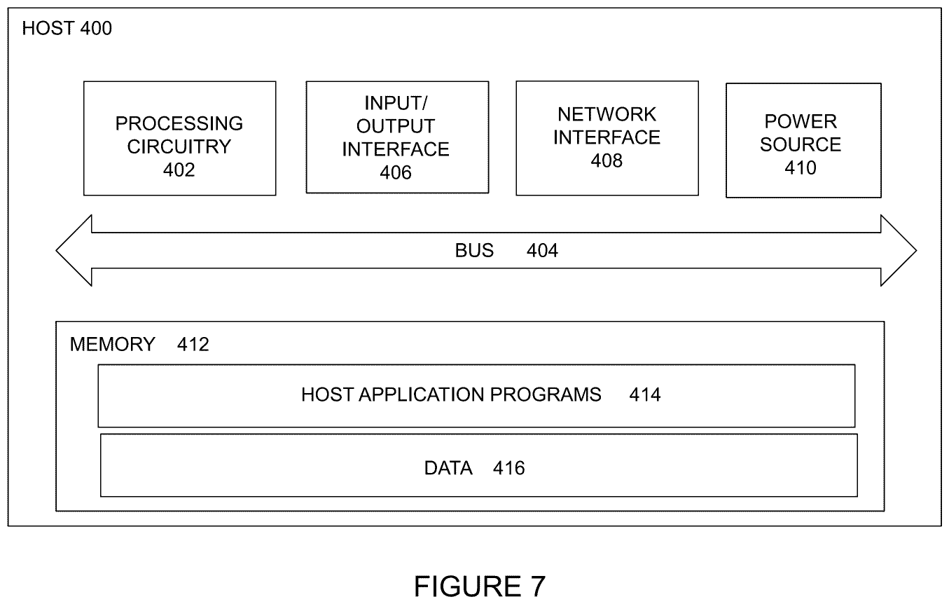

FIG. 7 is a block diagram of a host 400, which may be an embodiment of the host 116 of FIG. 4, in accordance with various aspects described herein.

As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

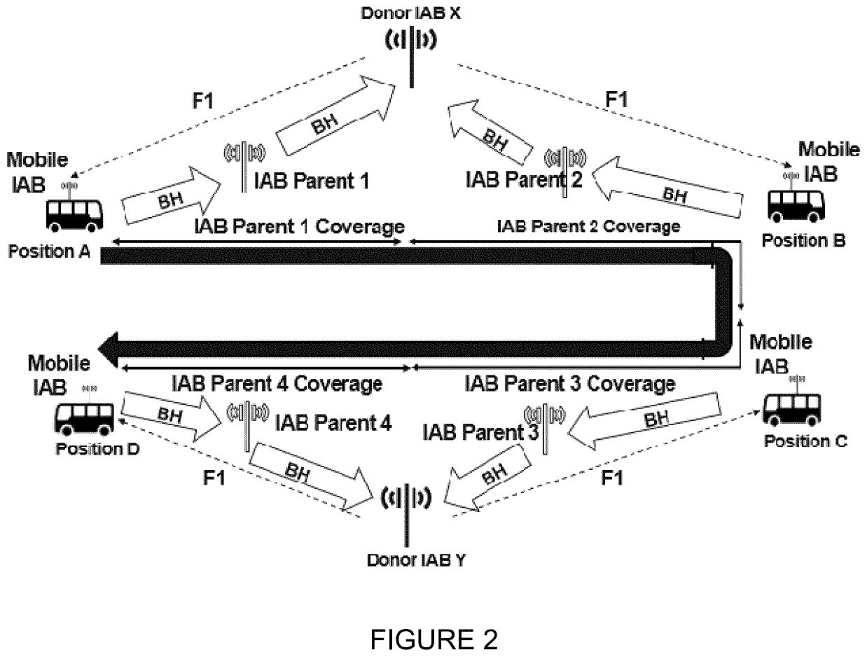

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 2 and 3, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

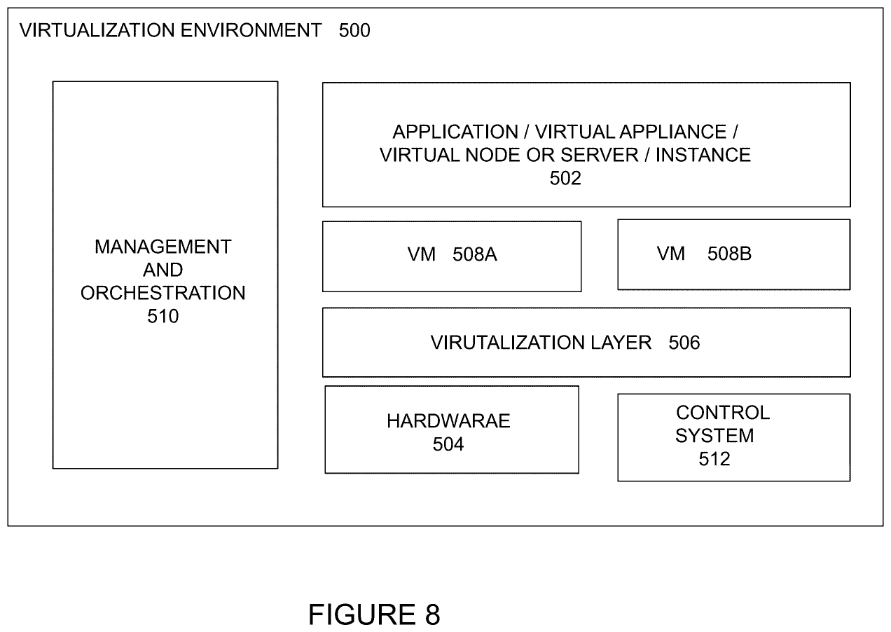

FIG. 8 is a block diagram illustrating a virtualization environment 500 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

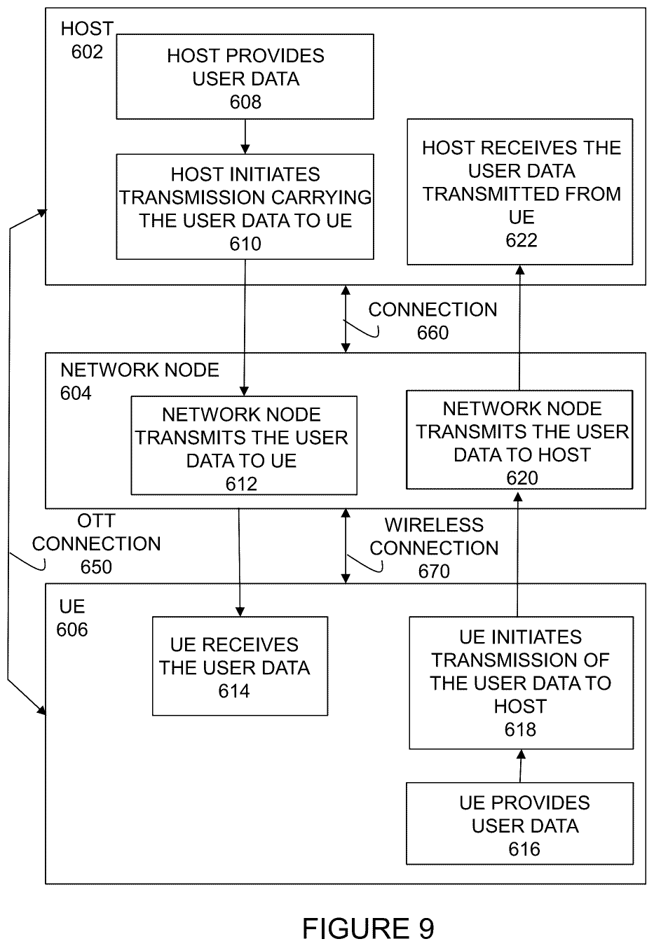

FIG. 9 shows a communication diagram of a host 602 communicating via a network node 604 with a UE 606 over a partially wireless connection in accordance with some embodiments.

Example implementations, in accordance with various embodiments, of the UE (such as a UE 112a of FIG. 4 and/or UE 200 of FIG. 5), network node (such as network node 110a of FIG. 4 and/or network node 300 of FIG. 6), and host (such as host 116 of FIG. 4 and/or host 400 of FIG. 7) discussed in the preceding paragraphs will now be described with reference to FIG. 9.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 4) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

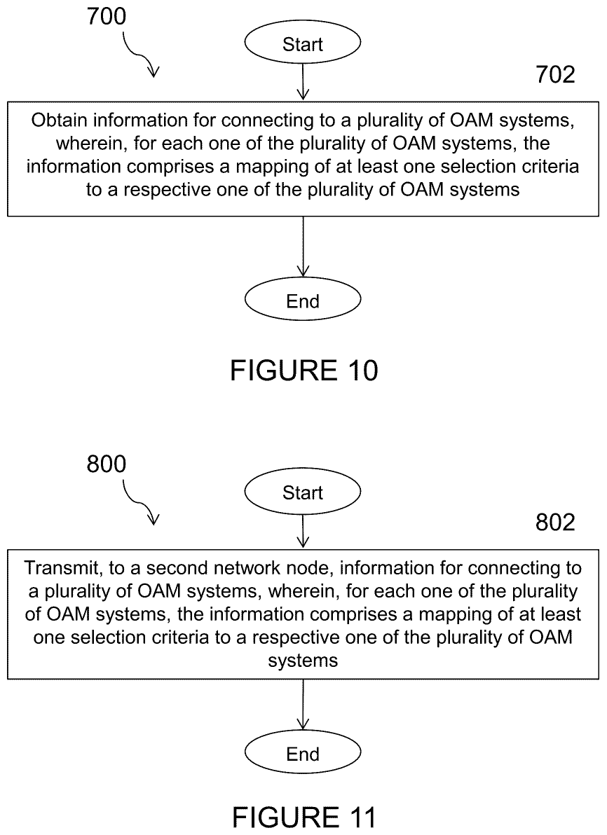

FIG. 10 illustrates an example method 700 by a network node 110 for handling OAM connectivity, according to certain embodiments. As illustrated the method begins at step 702 when the network node 110 obtains information for connecting to a plurality of OAM systems. For each one of the plurality of OAM systems, the information comprises a mapping of at least one selection criteria to a respective one of the plurality of OAM systems.

In a particular embodiment, the at least one selection criteria comprises at least one of: a gNB ID, of a donor CU that currently serves the network node 110; a gNB ID of a gNodeB that currently serves the network node 110; an identifier of a cell that the network node 110 is connected to; at least one of a Tracking Area Identity, Tracking Area Code, a Radio Access network Notification Area Code, and Registration Area associated with a cell to which the network node 110 is connected; a PLMN ID associated with a cell that currently serves the network node 110; at least one current geographical coordinate of the network node 110; positioning information of the network node 110; and information received from at least one UE served by the network

In a further particular embodiment, the TAI, TAC, RANAC, or RA may be associated with a cell served by the DU of the network node 110.

In a particular embodiment, the network node 110 is an IAB node, and the IAB node includes a mIAB-MT.

In a further particular embodiment, the IAB node comprises a plurality of logical mIAB-DUs.

In a particular embodiment, the information comprises at least one of: at least one parameter for establishing a connection with one or more of the plurality of OAM systems; at least one IP configuration and/or IP address associated with one or more of the plurality of OAM systems; at least one FQDN of Certification Authority/Registration Authority (CA/RA), SeGW, and SCS associated with one or more of the plurality of OAM systems; at least one IP configuration and/or IP address of CA/RA, SeGW and SCS associated with one or more of the plurality of OAM systems; and at least one identifier associated with one or more of the plurality of OAM systems. In a particular embodiment, the network node 110 is served by a first OAM system. Based on the obtained information, the network node 110 selects a second OAM system for serving the network node, and the second OAM system is different than the first OAM system.

In a further particular embodiment, when selecting the second OAM system, the network node 110 determines, based on the obtained information, whether the at least one selection criteria mapped to the second OAM system is fulfilled.

In a particular embodiment, when selecting the second OAM system the network node 110 initiates and/or establishes a connection with the second OAM system.

In a particular embodiment, prior to migration from a first location to a second location, the network node 110 has a first F1 connection between a first logical IAB-DU and a first donor-CU, and the first donor-CU is served by the first OAM system. After migration from the first location to the second location, the network node 110 establishes a second F1 connection between a second logical IAB-DU and a second donor-CU, and the second donor-CU is served by the second OAM system.

In a further particular embodiment, when obtaining the information for connecting to a plurality of OAM systems, the network node 110 performs at least one of: receiving the information from the first OAM system; receiving the information from the first donor-CU; receiving the information from the first logical IAB-DU; receiving the information from a mIAB-MT; obtaining the information from software stored on a host operating as the second logical IAB-DU; and obtaining the information from configuration information associated with the network node.

In a particular embodiment, upon being powered up and prior to establishing the second F1 connection with the second OAM system, the network node 110 selects the second OAM system based on the obtained information.

In a further particular embodiment, after establishing the second F1 connection with the second OAM system, the network node 110 downloads, by the second logical IAB-DU, configuration information and/or at least one configuration parameter, for the second OAM system.

In a further particular embodiment, the network node 110 initiates and/or establishes the second F1 connection with the second donor-CU based on the configuration information and/or the at least one configuration parameter.

FIG. 11 illustrates another example method 800 by a first network node 110 for handling OAM connectivity, according to certain embodiments. As illustrated, the method begins at step 802 when the first network node transmits, to a second network node, information for connecting to a plurality of OAM systems. For each of the plurality of OAM systems, the information comprises a mapping of at least one selection criteria to a respective one of the plurality of OAM systems.

In a particular embodiment, the at least one selection criteria comprises at least one of: a gNB ID of a donor CU that currently serves the second network node; a gNB ID of a gNodeB that currently serves the second network node; an identifier of a cell that the second network node is connected to; at least one of a Tracking Area Identity, Tracking Area Code, a Radio Access network Notification Area Code, and Registration Area associated with a cell to which the second network node is connected; a Public Land Mobile Network identifier, PLMN ID, associated with a cell that currently serves the second network node; at least one current geographical coordinate of the second network node; positioning information of the second network node; and information received from at least one UE served by the second network node.

In a particular embodiment, when transmitting the information to the second network node, the first network node 110 transmits the information to an IAB node, and the IAB node includes a mIAB-MT.

In a further particular embodiment, the IAB node comprises a plurality of logical mIAB-DUs.

In a particular embodiment, the information comprises at least one of: at least one parameter for establishing a connection with one or more of the plurality of OAM systems; at least one IP configuration and/or IP address associated with one or more of the plurality of OAM systems; at least one FQDN of CA/RA, SeGW, and SCS associated with one or more of the plurality of OAM systems; at least one IP configuration and/or IP address of CA/RA, SeGW, and SCS associated with one or more of the plurality of OAM systems; and at least one identifier associated with one or more of the plurality of OAM systems.

In a particular embodiment, the second network node selects one of the plurality of OAM systems based on the obtained information.

In a particular embodiment, prior to migration from a first location to a second location, the first network node 110 maintains a first F1 connection between a first logical IAB-DU, and a first donor-CU, and the first donor-CU is served by a first OAM system. After migration from the first location to the second location, a second FI connection is established between the second logical IAB-DU and a second donor-CU, and the second donor-CU is served by a selected OAM system.

In a particular embodiment, the first network node 110 comprises at least one of: the first OAM system; the first donor-CU; the first logical IAB-DU; and a mIAB-MT.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXAMPLE EMBODIMENTS

### Group A Example Embodiments

Example Embodiment A1. A method by a user equipment, the method comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node for handling of OAM connectivity, the method comprising: any of the network node steps, features, or functions described above, either alone or in combination with other steps, features, or functions described above

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a network node for handling of OAM connectivity, the method comprising: obtaining information for connecting to a plurality of OAM systems.

Example Embodiment C2. The method of Example Embodiment C1, wherein the information comprises a list of instructions.

Example Embodiment C3. The method of any one of Example Embodiments C1 to C2, wherein, for each one of the plurality of OAM systems, the information comprises a mapping of at least one selection criteria to the one of the plurality of OAM systems.

Example Embodiment C4. The method of any one of Example Embodiments C1 to C3, wherein the information comprises at least one of: at least one parameter for establishing a connection with one or more of the plurality of OAM systems; at least one IP address associated with one or more of the plurality of OAM systems; at least one TAC associated with one or more of the plurality of OAM systems; at least one FQDN associated with one or more of the plurality of OAM systems; and at least one identifier associated with one or more of the plurality of OAM systems.

Example Embodiment C5. The method of any one of Example Embodiments C1 to C4, wherein the network node is served by a first OAM system, and wherein the method comprises: based on the obtained information, selecting a second OAM system for serving the network node, wherein the second OAM system is different than the first OAM system.

Example Embodiment C6. The method of Example Embodiment C5, wherein selecting the second OAM system comprises: determining, based on the obtained information, whether at least one selection criteria and/or at least one condition associated with the second OAM system is fulfilled.

Example Embodiment C7. The method of any one of Example Embodiments C5 to C6, wherein selecting the second OAM system comprises: initiating and/or establishing a connection with the second OAM system.

Example Embodiment C8. The method of any one of Example Embodiments C4 to C7, wherein the at least one selection criteria and/or at least one condition comprises at least one of: a gNB ID pertaining to a donor CU that currently serves a mIAB-MT of the network node; a cell that the mIAB-MT is connected to, denoted by NR CGI or PCI; a Tracking Area Identity (TAI), Tracking Area Code (TAC) and/or the RAN Notification Area Code (RANAC), or Registration Area (RA) pertaining to a cell where the network node is connected; a Tracking Area Identity (TAI), Tracking Area Code (TAC) and/or the RAN Notification Area Code (RANAC), Registration Area (RA) pertaining to a cells served by a DU of the network node; a PLMN ID pertaining to a cell that currently serves the network node; at least one current geographical coordinate/positioning information of the network node; and information received from at least one UE served by the network node.

Example Embodiment C9. The method of any one of Example Embodiments C1 to C8, wherein the network node comprises a mIAB node, wherein the mIAB node comprises a plurality of logical mIAB-DUs.

Example Embodiment C10. The method of any one of Example Embodiments C1 to C9, wherein: prior to migration from a first location to a second location, the network node has a first FI connection between a first logical IAB-DU and a first donor-CU, wherein the first donor-CU is served by the first OAM system, and after migration from the first location to the second location, the network node establishes a second FI connection between a second logical IAB-DU and a second donor-CU, wherein the second donor-CU is served by the second OAM system.

Example Embodiment C11. The method of Example Embodiment C10, wherein obtaining the information for connecting to a plurality of OAM systems comprises at least one of: receiving the information from the first OAM system; receiving the information from the first donor-CU; receiving the information from the first logical IAB-DU; receiving the information from a mIAB-MT; obtaining the information from software (i.e., computer readable instructions) stored on a host operating as the second logical IAB-DU; and obtaining the information from configuration information (and/or a specification, standard, and/or manual) associated with the network node. Example Embodiment C12. The method of Example Embodiment C11, wherein the information is obtained by the second logical IAB-DU.

Example Embodiment C13. The method of any one of Example Embodiments C10 to C12, comprising powering up the second logical IAB-DU during or after migration from the first location to the second location.

Example Embodiment C14. The method of Example Embodiment C13, wherein, upon being powered up and prior to establishing the second F1 connection with the second OAM system, the second logical IAB-DU selects the second OAM system based on the obtained information.

Example Embodiment C15. The method of Example Embodiment C14, wherein, after establishing the second F1 connection with the second OAM system, the method comprises: downloading, by the second logical IAB-DU, configuration information and/or at least one configuration parameter, for the second OAM system.

Example Embodiment C16. The method of Example Embodiment C15, comprising: initiating and/or establishing the second F1 connection with the second donor-CU based on the configuration information and/or the at least one configuration parameter.

Example Embodiment C17. The method of any one of Example Embodiments C1 to C16, wherein the information is obtained during a power up and Plug and connect procedure.

Example Embodiment C18. The method of any one of Example Embodiments C1 to C17, wherein the information is obtained after migration from a first location associated with a first donor CU and/or first OAM system to a second location associated with a second donor CU and/or second OAM system.

Example Embodiment C19. The method of any of the previous Example Embodiments, further comprising: obtaining user data; and forwarding the user data to a host or a user equipment. Example Embodiment C20. A network node comprising processing circuitry configured to perform any of the methods of Example Embodiments C1 to C19.

Example Embodiment C21. A network node configured to perform any of the methods of Example Embodiments C1 to C19.

Example Embodiment C22. A computer program comprising instructions which when executed on a computer perform any of the methods of Example Embodiments C1 to C19.

Example Embodiment C23. A computer program product comprising computer program, the computer program comprising instructions which when executed on a computer perform any of the methods of Example Embodiments C1 to C19.

Example Embodiment C24. A non-transitory computer readable medium storing instructions which when executed by a computer perform any of the methods of Example Embodiments C1 to C19.

### Group D Example Embodiments

Example Embodiment D1. A method for handling of OAM connectivity, the method comprising: transmitting, to a second logical IAB-DU, information for connecting to a plurality of OAM systems.

Example Embodiment D2. The method of Example Embodiment D1, wherein the information comprises a list of instructions.

Example Embodiment D3. The method of any one of Example Embodiments D1 to D2, wherein, for each one of the plurality of OAM systems, the information comprises a mapping of at least one selection criteria to the one of the plurality of OAM systems.

Example Embodiment D4. The method of any one of Example Embodiments D1 to D3, wherein the information comprises at least one of: at least one parameter for establishing a connection with one or more of the plurality of OAM systems; at least one IP address associated with one or more of the plurality of OAM systems; at least one TAC associated with one or more of the plurality of OAM systems; at least one FQDN associated with one or more of the plurality of OAM systems; and at least one identifier associated with one or more of the plurality of OAM systems.

Example Embodiment D5. The method of any one of Example Embodiments D1 to D4, wherein the second logical IAB-DU selects one of the plurality of OAM systems based on the obtained information.

Example Embodiment D6. The method of Example Embodiment D5, wherein selecting the OAM system comprises: initiating and/or establishing a connection with the OAM system. Example Embodiment D7. The method of any one of Example Embodiments D3 to D6, wherein the at least one selection criteria and/or at least one condition comprises at least one of: a gNB ID associated with a donor CU that currently serves a mIAB-MT; a cell that the mIAB-MT is connected to, denoted by NR CGI or PCI; a Tracking Area Identity (TAI), Tracking Area Code (TAC) and/or the RAN Notification Area Code (RANAC), or Registration Area (RA); a PLMN ID; at least one current geographical coordinate/positioning information; and information received from at least one UE.

Example Embodiment D8. The method of any one of Example Embodiments D1 to D7, comprising: prior to migration from a first location to a second location, maintaining a first F1 connection between a first logical IAB-DU and a first donor-CU, wherein the first donor-CU is served by a first OAM system, and wherein, after migration from the first location to the second location, a second F1 connection is established between the second logical IAB-DU and a second donor-CU, wherein the second donor-CU is served by a selected OAM system.

Example Embodiment D9. The method of Example Embodiment D8, wherein transmitting the information comprises at least one of: transmitting the information from the first OAM system; transmitting the information from the first donor-CU; transmitting the information from the first logical IAB-DU; and transmitting the information from a mIAB-MT.

Example Embodiment D10. The method of Example Embodiment D9, wherein the information is transmitted during a power up and Plug and connect procedure.

Example Embodiment D11. The method of any of the previous Example Embodiments, further comprising: obtaining user data; and forwarding the user data to a host or a user equipment. Example Embodiment D12. A network node comprising processing circuitry configured to perform any of the methods of Example Embodiments D1 to D11.

Example Embodiment D13. A network node configured to perform any of the methods of Example Embodiments D1 to D11.

Example Embodiment D14. A computer program comprising instructions which when executed on a computer perform any of the methods of Example Embodiments D1 to D11.

Example Embodiment D15. A computer program product comprising computer program, the computer program comprising instructions which when executed on a computer perform any of the methods of Example Embodiments D1 to D11.

Example Embodiment D16. A non-transitory computer readable medium storing instructions which when executed by a computer perform any of the methods of Example Embodiments D1 to D11.

### Group E Example Embodiments

Example Embodiment E1. A user equipment for handling of OAM connectivity for mobile IAB-nodes, the UE comprising: processing circuitry configured to perform any of the steps of any of the Group A Example Embodiments; and power supply circuitry configured to supply power to the processing circuitry.

Example Embodiment E2. A network node for handling of OAM connectivity for mobile IAB-nodes, the network node comprising: processing circuitry configured to perform any of the steps of any of the Group B, C, and D Example Embodiments; power supply circuitry configured to supply power to the processing circuitry.

Example Embodiment E3. A user equipment (UE) for handling of OAM connectivity for mobile IAB-nodes, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment E4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A Example Embodiments to receive the user data from the host.

Example Embodiment E5. The host of the previous Example Embodiment, wherein the cellular network further includes a network node configured to communicate with the UE to transmit the user data to the UE from the host.

Example Embodiment E6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Embodiment E8. The method of the previous Example Embodiment, further comprising: at the host, executing a host application associated with a client application executing on the UE to receive the user data from the UE.

Example Embodiment E9. The method of the previous Example Embodiment, further comprising: at the host, transmitting input data to the client application executing on the UE, the input data being provided by executing the host application, wherein the user data is provided by the client application in response to the input data from the host application.

Example Embodiment E10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A Example Embodiments to transmit the user data to the host.

Example Embodiment E11. The host of the previous Example Embodiment, wherein the cellular network further includes a network node configured to communicate with the UE to transmit the user data from the UE to the host.

Example Embodiment E12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E13. A method implemented by a host configured to operate in a communication system that further includes a network node and a user equipment (UE), the method comprising: at the host, receiving user data transmitted to the host via the network node by the UE, wherein the UE performs any of the steps of any of the Group A Example Embodiments to transmit the user data to the host.

Example Embodiment E14. The method of the previous Example Embodiment, further comprising: at the host, executing a host application associated with a client application executing on the UE to receive the user data from the UE.

Example Embodiment E15. The method of the previous Example Embodiment, further comprising: at the host, transmitting input data to the client application executing on the UE, the input data being provided by executing the host application, wherein the user data is provided by the client application in response to the input data from the host application.

Example Embodiment E16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B, C, and D Example Embodiments to transmit the user data from the host to the UE.

Example Embodiment E17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment E18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B, C, and D Example Embodiments to transmit the user data from the host to the UE.

Example Embodiment E19. The method of the previous Example Embodiment, further comprising, at the network node, transmitting the user data provided by the host for the UE.

Example Embodiment E20. The method of any of the previous 2 Example Embodiments, wherein the user data is provided at the host by executing a host application that interacts with a client application executing on the UE, the client application being associated with the host

Example Embodiment E21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B, C, and D Example Embodiments to transmit the user data from the host to the UE.

Example Embodiment E22. The communication system of the previous Example Embodiment, further comprising: the network node; and/or the user equipment.

Example Embodiment E23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B, C, and D Example Embodiments to receive the user data from a user equipment (UE) for the host.

Example Embodiment E24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E25. The host of the any of the previous 2 Example Embodiments, wherein the initiating receipt of the user data comprises requesting the user data.

Example Embodiment E26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B, C, and D Example Embodiments to receive the user data from the UE for the host.

Example Embodiment E27. The method of the previous Example Embodiment, further comprising at the network node, transmitting the received user data to the host.

1. A method by a network node for handling of Operations and Maintenance, OAM, connectivity, the method comprising:
obtaining information for connecting to a plurality of OAM systems, and
wherein, for each one of the plurality of OAM systems, the information comprises a mapping of at least one selection criteria to a respective one of the plurality of OAM systems.

2-13. (canceled)

14. A method by a first network node for handling of Operations and Maintenance, OAM, connectivity, the method comprising:
transmitting, to a second network node, information for connecting to a plurality of OAM systems, and
wherein, for each of the plurality of OAM systems, the information comprises a mapping of at least one selection criteria to a respective one of the plurality of OAM systems.

15-21. (canceled)

22. A network node for handling of Operation and Maintenance, OAM, connectivity, the network node configured to:
obtain information for connecting to a plurality of OAM systems, and
wherein, for each of the plurality of OAM systems, the information comprises a mapping of at least one selection criteria to a respective one of the plurality of OAM systems.

23. The network node of claim 22, wherein the at least one selection criteria comprises at least one of:
a gNodeB identifier, gNB ID, of a donor Centralized Unit, CU, that currently serves the network node;
a gNB ID of a gNodeB that currently serves the network node;
an identifier of a cell that the network node is connected to;
at least one of a Tracking Area Identity, Tracking Area Code, a Radio Access network Notification Area Code, and Registration Area associated with a cell to which the network node is connected;
a Public Land Mobile Network identifier, PLMN ID, associated with a cell that currently serves the network node;
at least one current geographical coordinate of the network node;
positioning information of the network node; and
information received from at least one UE served by the network node.

24. The network node of claim 22 wherein:
the network node comprises a Integrated Access and Backhaul, IAB, node, and
the IAB node includes a Mobile IAB-Mobile Termination, mIAB-MT.

25. The network node of claim 24, wherein the IAB node comprises a plurality of logical Mobile IAB-Distributed Units, mIAB-DUs.

26. The network node of claim 22 wherein the information comprises at least one of:
at least one parameter for establishing a connection with one or more of the plurality of OAM systems;
at least one Internet Protocol, IP, configuration and/or IP address associated with one or more of the plurality of OAM systems;
at least one Fully Qualified Domain Name, FQDN, of Certification Authority/Registration Authority, CA/RA, Security Gateway, SeGW, and Subcarrier Spacing, SCS, associated with one or more of the plurality of OAM systems;
at least one IP configuration and/or IP address of CA/RA, SeGW and SCS associated with one or more of the plurality of OAM systems; and
at least one identifier associated with one or more of the plurality of OAM systems.

27. The network node of claim 22, wherein the network node is served by a first OAM system, and wherein the method comprises:
based on the obtained information, selecting a second OAM system for serving the network node, wherein the second OAM system is different than the first OAM system.

28. The network node of claim 27, wherein when selecting the second OAM system the network node is configured to:
determine, based on the obtained information, whether the at least one selection criteria mapped to the second OAM system is fulfilled.

29. The network node of claim 27, wherein when selecting the second OAM system the network node is configured to:
initiate and/or establish a connection with the second OAM system.

30. The network node of claim 22, wherein:
prior to migration from a first location to a second location, the network node has a first F1 connection between a first logical Integrated Access and Backhaul-Distributed Unit, IAB-DU, and a first donor-Centralized Unit, CU, wherein the first donor-CU is served by the first OAM system, and after migration from the first location to the second location, the network node establishes a second F1 connection between a second logical IAB-DU and a second donor-CU, wherein the second donor-CU is served by the second OAM system.

31. The network node of claim 30, wherein when obtaining the information for connecting to a plurality of OAM systems, the network node is configured to perform at least one of:
receiving the information from the first OAM system;
receiving the information from the first donor-CU;
receiving the information from the first logical IAB-DU;
receiving the information from a mIAB-MT;
obtaining the information from software stored on a host operating as the second logical IAB-DU; and
obtaining the information from configuration information associated with the network node.

32. The network node of claim 22, wherein, upon being powered up and prior to establishing the second F1 connection with the second OAM system, the network node is configured to select the second OAM system based on the obtained information.

33. The network node of claim 32, wherein, after establishing the second F1 connection with the second OAM system, the network node is configured to:
download, by the second logical IAB-DU, configuration information and/or at least one configuration parameter, for the second OAM system.

34. The network node of claim 33, configured to: initiate and/or establish the second F1 connection with the second donor-CU based on the configuration information and/or the at least one configuration parameter.

35. A first network node for handling of Operation and Maintenance, OAM, connectivity, the network node configured to:
transmit, to a second network node information for connecting to a plurality of OAM systems, and
wherein, for each of the plurality of OAM systems, the information comprises a mapping of at least one selection criteria to a respective one of the plurality of OAM systems.

36. The first network node of claim 35, wherein the at least one selection criteria comprises at least one of:
a gNodeB identifier, gNB ID, of a donor Centralized Unit, CU, that currently serves the second network node;
a gNB ID of a gNodeB that currently serves the second network node;
an identifier of a cell that the second network node is connected to;
at least one of a Tracking Area Identity, Tracking Area Code, a Radio Access network Notification Area Code, and Registration Area associated with a cell to which the second network node is connected;
a Public Land Mobile Network identifier, PLMN ID, associated with a cell that currently serves the second network node;
at least one current geographical coordinate of the second network node;
positioning information of the second network node; and
information received from at least one UE served by the second network node.

37. The first network node of claim 35, wherein transmitting the information to the second network node comprises transmitting the information to an Integrated Access and Backhaul, IAB, node, and wherein the IAB node includes a Mobile IAB-Mobile Termination, mIAB-MT.

38. The first network node of claim 37, wherein the IAB node comprises a plurality of logical Mobile IAB-Distributed Units, mIAB-DUs.

39. The first network node of claim 35 wherein the information comprises at least one of:
at least one parameter for establishing a connection with one or more of the plurality of OAM systems;
at least one Internet Protocol, IP, configuration and/or IP address associated with one or more of the plurality of OAM systems;
at least one Fully Qualified Domain Name, FQDN, of Certification Authority/Registration Authority, CA/RA, Security Gateway, SeGW, and Subcarrier Spacing, SCS, associated with one or more of the plurality of OAM systems;
at least one IP configuration and/or IP address of CA/RA, SeGW, and SCS associated with one or more of the plurality of OAM systems; and
at least one identifier associated with one or more of the plurality of OAM systems.

40. The first network node of claim 35, wherein the second network node selects one of the plurality of OAM systems based on the obtained information.

41. The first network node of claim 35, configured to:
prior to migration from a first location to a second location, maintain a first F1 connection between a first logical Integrated Access and Backhaul-Distributed Unit, IAB-DU, and a first donor-Centralized Unit, CU, wherein the first donor-CU is served by a first OAM system, and
wherein, after migration from the first location to the second location, a second Fl connection is established between the second logical IAB-DU and a second donor-CU, wherein the second donor-CU is served by a selected OAM system.

42. The first network node of claim 40, wherein the first network node comprises at least one of:
the first OAM system;
the first donor-CU;
the first logical IAB-DU; and
a Mobile Integrated Access and Backhaul-Mobile Termination, mIAB-MT.
